(19) United States
(12) Patent Application Publication
(10) Pub. No.: US 2017/0041150 A1
(43) Pub. Date: Feb. 9, 2017

(54) DEVICE CERTIFICATE PROVIDING APPARATUS, DEVICE CERTIFICATE PROVIDING SYSTEM, AND NON-TRANSITORY COMPUTER READABLE RECORDING MEDIUM WHICH STORES DEVICE CERTIFICATE PROVIDING PROGRAM

(71) Applicant: MITSUBISHI ELECTRIC CORPORATION, Tokyo (JP)

(72) Inventors: Takehiro ISHIGURO, Tokyo (JP); Ikumi MORI, Tokyo (JP)

(73) Assignee: MITSUBISHI ELECTRIC CORPORATION, Tokyo (JP)

(21) Appl. No.: 15/039,979

(22) PCT Filed: Jan. 27, 2014
(86) PCT No.: PCT/JP2014/051687

§ 371 Date: May 27, 2016

(51) Int. Cl. H04L 9/32; H04L 9/30; H04W 12/04; H04L 9/14; H04L 29/06; H04W 12/06

(52) U.S. Cl. CPC H04L 9/3263; H04L 63/0823; H04W 12/06; H04L 63/06; H04W 12/04; H04L 63/083; H04L 9/14; H04L 9/30

(57) ABSTRACT

A device ID inquiry unit transmits a device ID request containing an IP address as a communication address of a destination, and receives a communication device identifier from a communication device. A device ID determination unit checks whether or not the communication device identifier is the same device identifier as a device ID. If the communication device identifier is the same device identifier as the device ID, a public key acquisition unit acquires a device public key from the communication device, and a device certificate transmission unit transmits a device certificate containing the device public key to the communication device.

### TECHNICAL FIELD

The present invention relates to a technique for installing a digital certificate to a communication device.

### BACKGROUND ART

Patent Literature 1 discloses a technique relating to an authentication system where a server, a certificate authority (CA), a device, and a registration terminal exist.

In this technique, a temporary public key certificate not correlated to device information and a non-temporary public key certificate correlated to the device information are used as follows so that the device is connected to the server.

First, the registration terminal acquires the temporary public key certificate from the certificate authority and writes the acquired temporary public key certificate into an IC card (IC: Integrated Circuit). A secret key and a public key of the device have been written in the IC card.

The user connects the IC card to the device. The device, by using its own device information and the temporary public key certificate written in the IC card, requests the certificate authority to issue the non-temporary public key certificate, and acquires the non-temporary public key certificate from the certificate authority.

Patent Literature 2 discloses a technique for an authentication device, an upper-order device, and a lower-order device to communicate with each other securely.

In this technique, the devices authenticate each other by using individual public key certificates, so that secure communication is ensured. If the individual public key certificate of the lower-order device is damaged, the upper-order device authenticates the lower-order device based on information of the lower-order device and a common public key certificate that is common to the devices. The lower-order device acquires an individual public key certificate from the authentication device via the upper-order device.

Namely, in order to restore the individual public key certificate in accordance with the technique of Patent Literature 2, the common public key certificate need be installed in each device in advance.

However, there may be cases where it is difficult to install the common public key certificate to each device in advance. For example, if the device manufacturer and the service provider are different parties, it is difficult in the manufacture of the device to install a common public key certificate issued by the service provider, to the device.

### CITATION LIST

### Patent Literature

Patent Literature 1: WO 2007/099608

Patent Literature 2: JP 2005-65236

### SUMMARY OF INVENTION

### Technical Problem

It is an object of the present invention to enable safe installation of a digital certificate to a communication device.

### Solution to Problem

A device certificate providing apparatus according to the present invention includes:

a device identifier storage unit to store a first device identifier and a first communication address;

a device identifier inquiry unit to transmit a device identifier request containing, as a communication address of a destination, the first communication address stored in the device identifier storage unit, to a network connected to not less than one communication device, and receives, from a first communication device out of the not less than one communication device, a communication device identifier that identifies the first communication device;

a device identifier determination unit to determine whether or not the communication device identifier received by the device identifier inquiry unit is the same device identifier as the first device identifier stored in the device identifier storage unit; and

a device certificate transmission unit to transmit a device certificate being a digital certificate of the first communication device to the first communication device if it is determined by the device identifier determination unit that the communication device identifier is the same device identifier as the first device identifier.

### Advantageous Effects of Invention

According to the present invention, a digital certificate can be installed in a communication device safely.

### BRIEF DESCRIPTION OF DRAWINGS

FIG. 1 is a configuration diagram of a device authentication system 100 according to Embodiment 1.

FIG. 2 is a functional configuration diagram of a security GW 200 according to Embodiment 1.

FIG. 3 is a functional configuration diagram of a device information server 300 according to Embodiment 1.

FIG. 4 is a diagram illustrating a user information file 391 according to Embodiment 1.

FIG. 5 is a diagram illustrating a device information file 392 according to Embodiment 1.

FIG. 6 is a functional configuration diagram of a communication device 400 according to Embodiment 1.

FIG. 7 is a flowchart illustrating a device certificate installation process of the device authentication system 100 according to Embodiment 1.

FIG. 8 is a flowchart illustrating a device information acquisition process (S110) according to Embodiment 1.

FIG. 9 is a diagram illustrating an example of a hardware configuration of the security GW 200 according to Embodiment 1.

### DESCRIPTION OF EMBODIMENTS

### Embodiment 1

An embodiment of installation of a digital certificate to a communication device will be described.

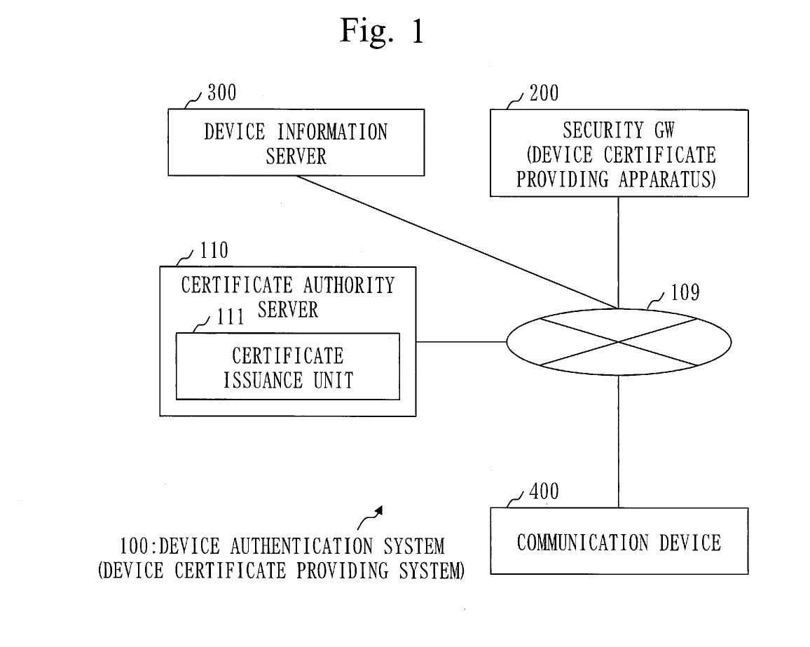

FIG. 1 is a configuration diagram of a device authentication system 100 according to Embodiment 1.

The configuration of the device authentication system 100 according to Embodiment 1 will be described with reference to FIG. 1.

The device authentication system 100 (an example of a device certificate providing system) is a system in which a digital certificate is installed into a communication device 400 so that the communication device 400 can communicate using the digital certificate. The digital certificate may also be called public key certificate. The public key certificate certifies the holder (for example, the communication device 400) of a public key.

The device authentication system 100 includes a security GW 200 (GW: gateway), a device information server 300, a communication device 400, and a certificate authority server 110 which communicate with each other via a network 109.

The security GW 200 (an example of a device certificate providing apparatus) is a device which provides a digital certificate to the communication device 400.

The device information server 300 is a device which manages device information concerning the communication device 400.

The communication device 400 is a device which communicates by using the digital certificate provided by the security GW 200.

The certificate authority server 110 is a device which issues the digital certificate.

The certificate authority server 110 includes a certificate issuance unit 111 which issues the digital certificate.

The certificate authority server 110 also includes a certificate authority storage unit (not illustrated) which stores the secret key (to be referred to as certificate authority secret key hereinafter) and so on of the certificate authority server 110.

Hereinafter, the digital certificate of the communication device 400 will be referred to as a device certificate, the pubic key of the communication device 400 will be referred to as a device public key, and the secret key of the communication device 400 will be referred to as a device secret key.

The digital certificate of the security GW 200 will be referred to as a GW certificate, the public key of the security GW 200 will be referred to as a GW public key, and the secret key of the security GW 200 will be referred to as a GW secret key.

The digital certificate of the device information server 300 will be referred to as a server certificate, the public key of the device information server 300 will be referred to as a server public key, and the secret key of the device information server 300 will be referred to as a server secret key.

FIG. 2 is a functional configuration diagram of the security GW 200 according to Embodiment 1.

The functional configuration of the security GW 200 according to Embodiment 1 will be described with reference to FIG. 2.

The security GW 200 (an example of the device certificate providing apparatus) includes a mutual authentication unit 210, a cryptographic communication unit 220, a device ID registration unit 230 (ID: identifier), a device certificate installation unit 240, and a security GW storage unit 290.

The mutual authentication unit 210 authenticates a communication partner with using the digital certificate of the communication partner, and is authenticated by the communication partner with using the digital certificate (GW certificate) of the security GW 200.

The cryptographic communication unit 220 encrypts communication data by using a public key contained in the digital key certificate of the communication partner and transmits the encrypted communication data to the communication partner.

The cryptographic communication unit 220 receives the encrypted communication data from the communication partner and decrypts the received communication data by using the secret key (GW secret key) of the security GW 200.

The device ID registration unit 230 (an example of a device identifier acquisition unit and device information acquisition unit) transmits a device ID 291 (for example, a serial number) for identifying the communication device 400, to the device information server 300, and receives device information 292 concerning the communication device 400.

The device information 292 includes an IP address 293 (IP: Internet Protocol), a MAC address 294 (MAC: Media Access Control), and so on.

The device certificate installation unit 240 installs a device certificate 494 to the communication device 400.

The device certificate installation unit 240 includes a device ID inquiry unit 241, a device ID determination unit 242, a public key acquisition unit 243, a device certificate acquisition unit 244, and a device certificate transmission unit 245.

The device ID inquiry unit 241 receives a device ID from the communication device 400 or an unauthorized communication device connected to the network 109.

The device ID determination unit 242 checks whether or not the received device ID is the same as the device ID 291 stored in the security GW storage unit 290.

The public key acquisition unit 243 receives a device public key 492 from the communication device 400 which has transmitted the device ID that is the same as the device ID 291.

The device certificate acquisition unit 244 acquires the device certificate 494 containing the device public key 492 from the certificate authority server 110.

The device certificate transmission unit 245 transmits the device certificate 494 to the communication device 400.

The security GW storage unit 290 stores data which the security GW 200 uses, generates, or takes as input or outputs.

For example, the security GW storage unit 290 stores the device information 292 (an example of the first communication address and first device information), the device public key 492, and the device certificate 494 in correlation with the device ID 291 (an example of the first device identifier). The security GW storage unit 290 also stores the GW certificate containing a GW public key; the GW secret key; a server certificate containing the server public key; and so on (not illustrated).

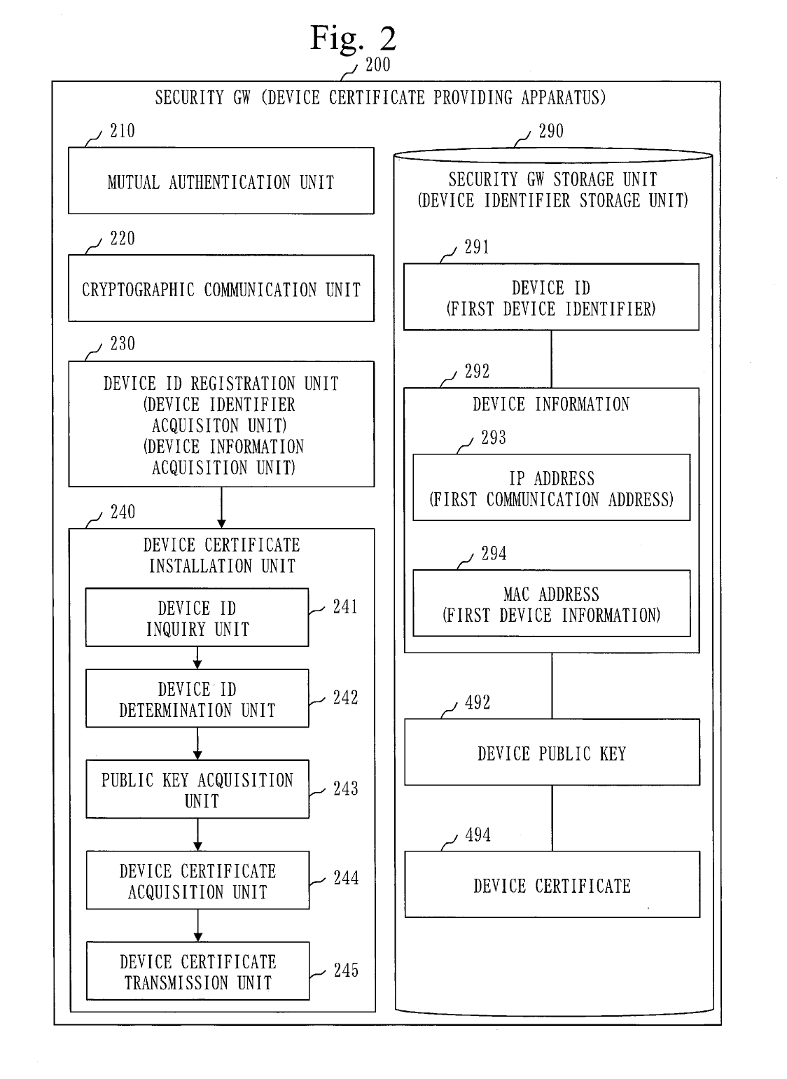

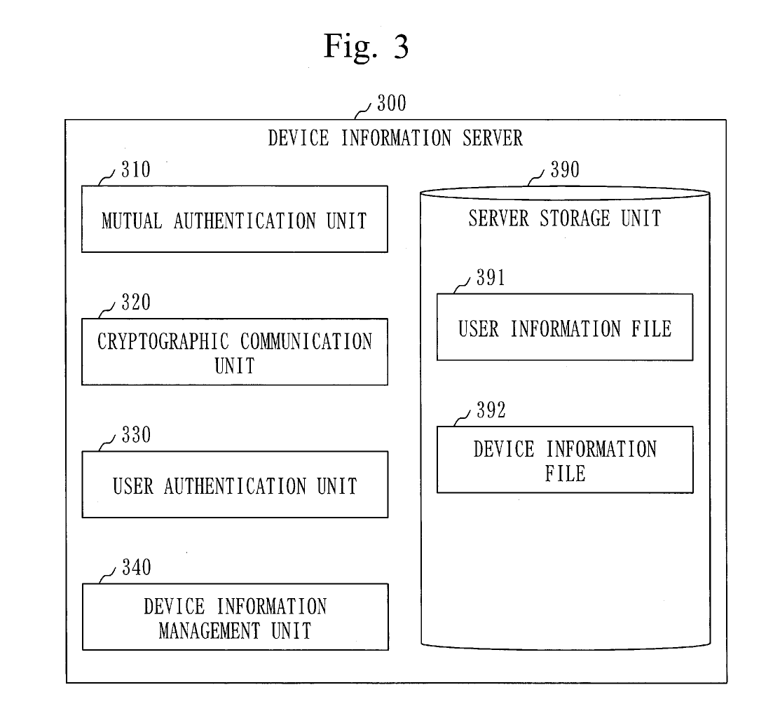

FIG. 3 is a functional configuration diagram of the device information server 300 according to Embodiment 1.

The functional configuration of the device information server 300 according to Embodiment 1 will be described with reference to FIG. 3.

The device information server 300 includes a mutual authentication unit 310, a cryptographic communication unit 320, a user authentication unit 330, a device information management unit 340, and a server storage unit 390.

The mutual authentication unit 310 authenticates the communication partner by using the digital certificate of the communication partner and is authenticated by the communication partner by using the digital certificate (server certificate) of the device information server 300.

The cryptographic communication unit 320 encrypts the communication data by using the public key contained in the digital certificate of the communication partner and transmits the encrypted communication data to the communication partner.

The cryptographic communication unit 320 receives the encrypted communication data from the communication partner and decrypts the received communication data by using the secret key (server secret key) of the device information server 300.

The user authentication unit 330 authenticates the user who uses the security GW 200, based on a user information file 391.

The device information management unit 340 transmits the device information contained in a device information file 392 to the security GW 200.

The server storage unit 390 stores the data which the device information server 300 uses, generates, or takes as input or outputs.

For example, the server storage unit 390 stores the user information file 391 and the device information file 392. The server storage unit 390 also stores the server certificate containing the server public key; the server secret key; the GW certificate containing the GW public key; and so on (not illustrated).

The user information file 391 contains user information concerning the user permitted to use the security GW 200.

The device information file 392 contains device information concerning the communication device 400 to which the device certificate is to be installed.

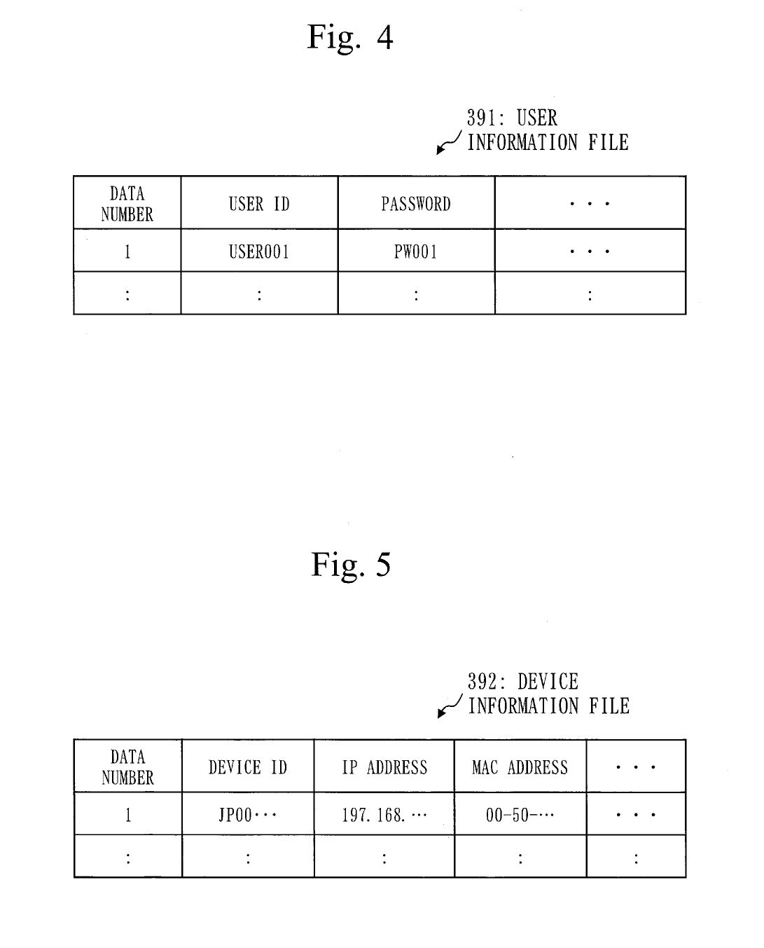

FIG. 4 is a diagram illustrating the user information file 391 according to Embodiment 1.

The user information file 391 according to Embodiment 1 will be described with reference to FIG. 4.

The user information file 391 contains user data of each user.

The user data includes a data number to identify the user data, and the user information (user ID, password, and so on) concerning the user.

FIG. 5 is a diagram illustrating the device information file 392 according to Embodiment 1.

The device information file 392 according to Embodiment 1 will be described with reference to FIG. 5.

The device information file 392 contains device data of each communication partner.

The device data includes a data number which identifies the device data, a device ID which identifies the communication device, and device information (IP address, MAC address, or the like) concerning the communication device.

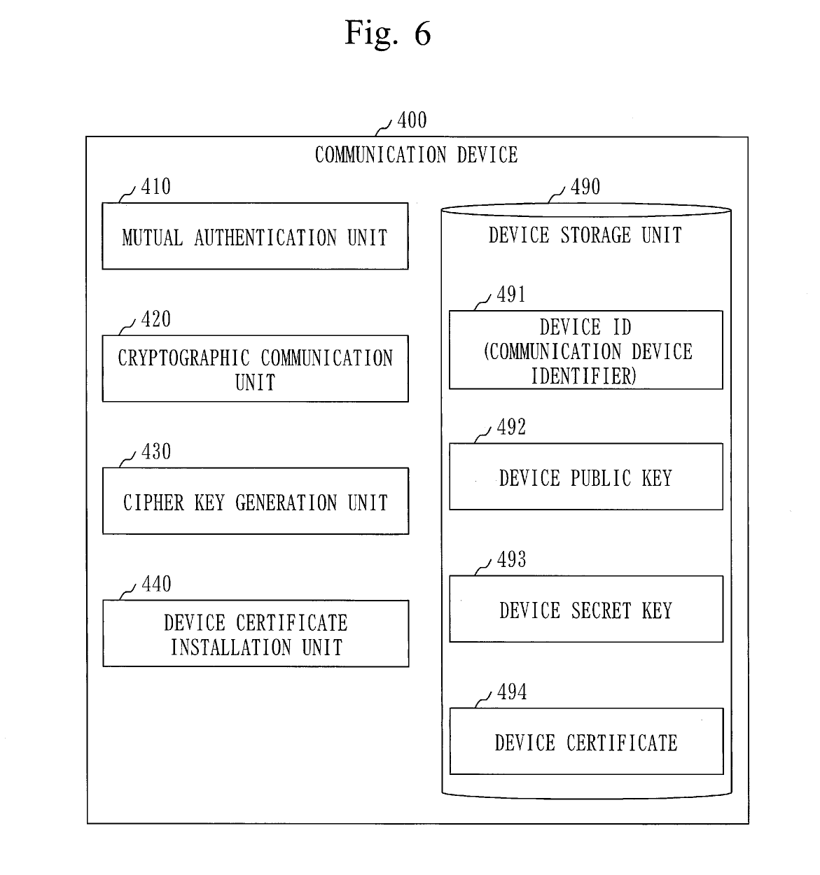

FIG. 6 is a functional configuration diagram of the communication device 400 according to Embodiment 1.

The functional configuration of the communication device 400 according to Embodiment 1 will be described with reference to FIG. 6.

The communication device 400 includes a mutual authentication unit 410, a cryptographic communication unit 420, a cipher key generation unit 430, a device certificate installation unit 440, and a device storage unit 490.

The mutual authentication unit 410 authenticates the communication partner by using the digital certificate of the communication partner and is authenticated by the communication partner by using the digital certificate (device certificate 494) of the communication device 400.

The cryptographic communication unit 420 encrypts the communication data by using the public key contained in the digital key certificate of the communication partner and transmits the encrypted communication data to the communication partner.

The cryptographic communication unit 420 receives the encrypted communication data from the communication partner and decrypts the received communication data by using the secret key (device secret key 493) of the communication device 400.

The cipher key generation unit 430 generates the device public key 492 and a device secret key 493 based on a key generation algorithm of a public key scheme.

The device certificate installation unit 440 receives the device certificate 494 transmitted from the security GW 200 and stores the received device certificate 494 to the device storage unit 490.

The device storage unit 490 stores the data which the communication device 400 uses, generates, or takes as input or outputs.

For example, the device storage unit 490 stores a device ID 491, the device public key 492, the device secret key 493, and the device certificate 494. The device storage unit 490 also stores the digital certificate of the communication partner which contains the public key of the communication partner (not illustrated).

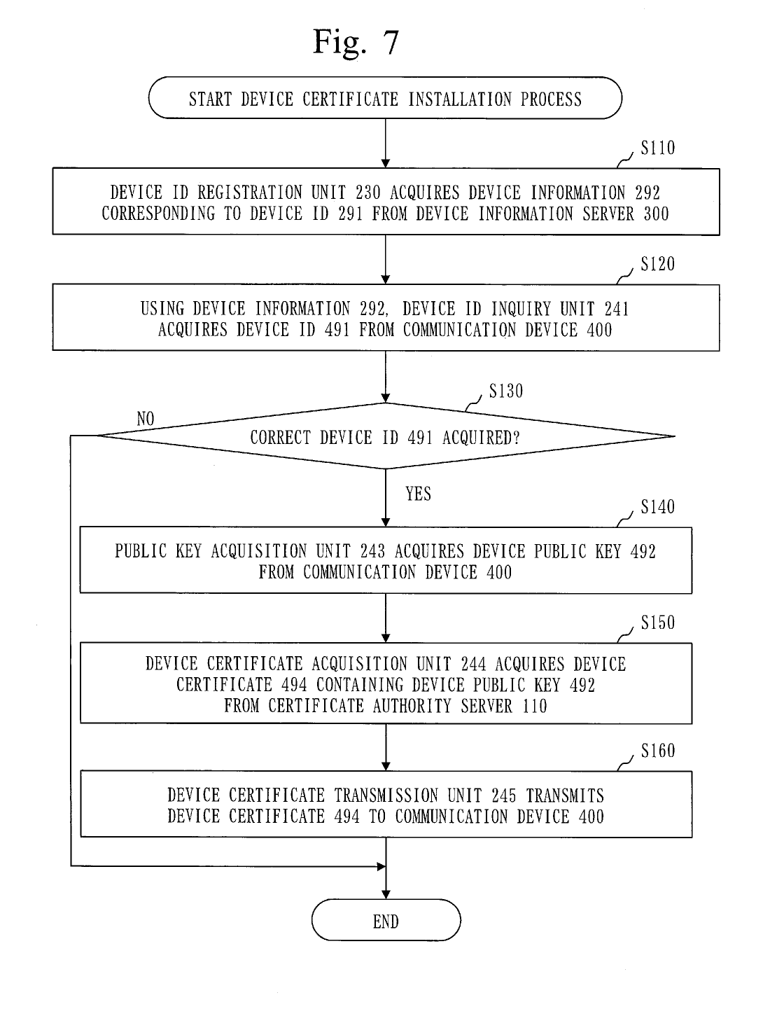

FIG. 7 is a flowchart illustrating a device certificate installation process of the device authentication system 100 according to Embodiment 1.

The device certificate installation process of the device authentication system 100 according to Embodiment 1 will be described with reference to FIG. 7.

First, the outline of the device certificate installation process will be described.

The device ID registration unit 230 acquires the device information 292 corresponding to the device ID 291 from the device information server 300 (S110).

Using the information included in the device information 292, the device ID inquiry unit 241 acquires the device ID 491 from the communication device 400 (S120).

If a device ID 491 that is the same as the device ID 291 is acquired, the public key acquisition unit 243 acquires the device public key 492 from the communication device 400 (S140).

The device certificate acquisition unit 244 acquires the device certificate 494 containing the device public key 492, from the certificate authority server 110 (S150).

The device certificate transmission unit 245 transmits the device certificate 494 to the communication device 400 (S160).

With the above device certificate installation process, the device certificate 494 is installed in the communication device 400.

The device certificate installation process in detail will now be described.

In S110, the device ID registration unit 230 of the security GW 200 acquires the device information 292 corresponding to the device ID 291 from the device information server 300.

The device information acquisition process (S110) in detail will be described later.

After S110, the process proceeds to S120.

In S120, the device ID inquiry unit 241 of the security GW 200 generates a device ID request by using the IP address 293 included in the device information 292, as the communication address of the destination, and transmits the generated device ID request to the network 109. Alternatively, the device ID inquiry unit 241 may transmit the device ID request by using the MAC address 294 as the communication address of the destination.

The device ID request is communication data that requests, from the communication device 400 identified by the device ID 291, the device ID 491 stored in the communication device 400.

The device certificate installation unit 440 of the communication device 400 receives the device ID request, generates a device ID response, and transmits the generated device ID response to the security GW 200.

The device ID response is communication data including the device ID 491 stored in the device storage unit 490.

The device ID inquiry unit 241 of the security GW 200 receives the device ID response containing the device ID 491.

At this time, the device ID inquiry unit 241 is likely to receive a device ID response transmitted from an unauthorized communication device.

Where the communication device 400 is not connected to the network 109 (including a case where the communication device 400 is OFF), the device ID inquiry unit 241 cannot receive the device ID response from the communication device 400.

After S120, the process proceeds to S130.

In S130, the device ID determination unit 242 of the security GW 200 compares the device ID 491 contained in the device ID response with the device ID 291 stored in the security GW storage unit 290.

If the device ID 491 and the device ID 291 are not the same, the device ID determination unit 242 discards the device ID 491 and waits until a device ID response containing a device ID 491 that is the same as the device ID 291 is received.

If a device ID response containing a device ID 491 that is the same as the device ID 291 is received before the lapse of the wait time for the device ID response (YES), the process proceeds to S140.

If a device ID response containing a device ID 491 that is the same as the device ID 291 is not received before the lapse of the wait time for the device ID response (NO), the device ID determination unit 242 displays a message indicating that the communication device 400 is not connected to the network 109. In this case, the device certificate 494 is not installed in the communication device 400, and the device certificate installation process ends.

In S140, the public key acquisition unit 243 of the security GW 200 transmits a public key request to the communication device 400. The communication device 400 is the device that has transmitted the device ID response containing the device ID 491 that is the same as the device ID 291.

The public key request is communication data that requests the device public key 492 from the communication device 400.

The device certificate installation unit 440 of the communication device 400 receives the public key request, generates a public key response being communication data including the device public key 492, and transmits the generated public key response to the security GW 200.

The cipher key generation unit 430 may generate the device public key 492 and device secret key 493 at this timing, or may generate the device public key 492 and the device secret key 493 in advance.

The public key acquisition unit 243 of the security GW 200 receives the public key response containing the device public key 492.

After S140, the process proceeds to S150.

In S150, the device certificate acquisition unit 244 of the security GW 200 generates a certificate request containing the device public key 492 and the device information 292 (and may contain the device ID 291 as well) and transmits the generated certificate request to the certificate authority server 110.

The certificate request is communication data that requests the device certificate 494.

The certificate issuance unit 111 of the certificate authority server 110 receives the certificate request, acquires the device public key 492 and device information 292 from the certificate request, and generates a digital signature (to be also referred to as certificate authority signature hereinafter) of the certificate authority server 110 by using the device public key 492, the device information 292, and the certificate authority secret key.

Then, the certificate issuance unit 111 generates the device certificate 494 containing the device public key 492, the device information 292, and the certificate authority signature, generates a certificate response being communication data including the generated device certificate 494, and transmits the generated certificate response to the security GW 200.

The device certificate acquisition unit 244 of the security GW 200 receives the certificate response containing the device certificate 494.

After S150, the process proceeds to S160.

In S160, the device certificate transmission unit 245 of the security GW 200 transmits the device certificate 494 to the communication device 400.

The device certificate installation unit 440 of the communication device 400 receives the device certificate 494 and stores the received device certificate 494 to the device storage unit 490.

Thus, the device certificate 494 is installed in the communication device 400.

After the device certificate 494 is installed, the communication device 400 is able to get an authentication from the communication partner, by using the device certificate 494 and the device secret key 493. The communication device 400 is also able to carry out encrypted communication (concealed communication) by using the device certificate 494 and device secret key 493.

The device certificate is not installed in an unauthorized communication device. Thus, the unauthorized communication device cannot get an authentication from the communication partner (for example, the communication device 400, the security GW 200, or the device information server 300) and cannot communicate with the communication partner.

After S160, the device certificate installation process is ended.

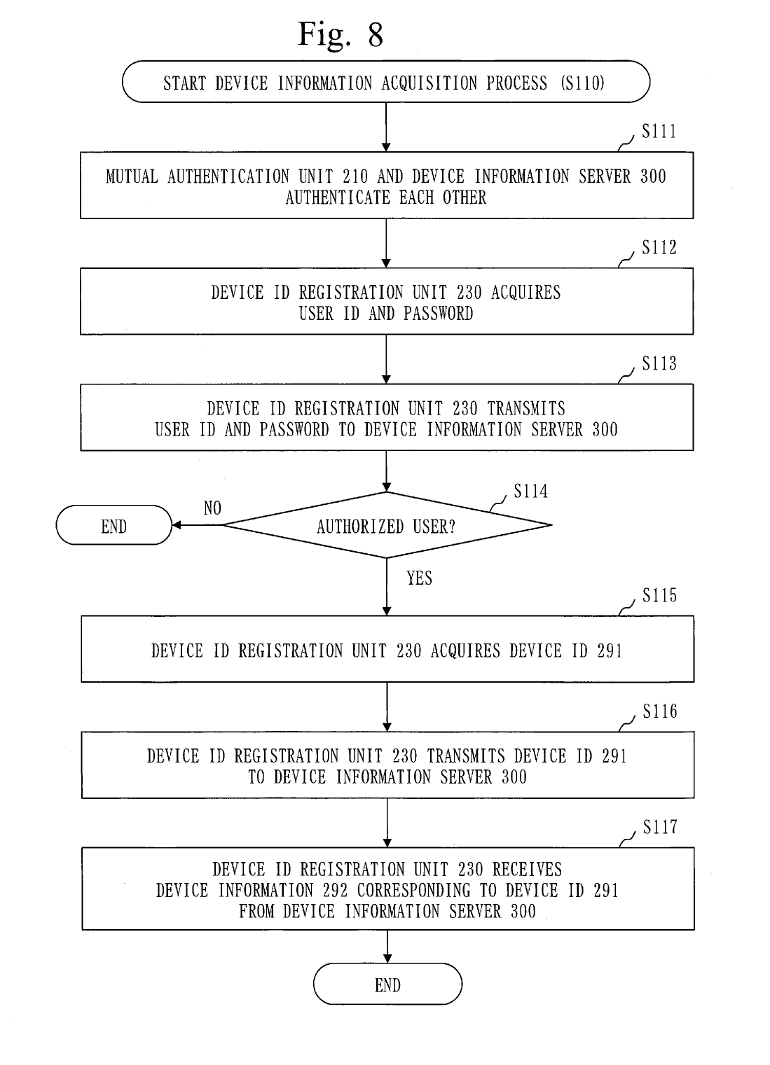

FIG. 8 is a flowchart illustrating a device information acquisition process (S110) according to Embodiment 1.

The device information acquisition process (S110) according to Embodiment 1 will be described with reference to FIG. 8.

In S111, the mutual authentication unit 210 of the security GW 200 transmits the GW certificate to the device information server 300 and receives the server certificate from the device information server 300.

The mutual authentication unit 210 confirms that the communication partner is the device information server 300 based on the server information (information concerning the device information server 300) contained in the received server certificate.

The mutual authentication unit 210 encrypts an authentication code by using the GW secret key and transmits the encrypted authentication code to the device information server 300.

The mutual authentication unit 210 receives the encrypted authentication code from the device information server 300 by using the server secret key, and decrypts the received authentication code by using the server public key contained in the server certificate.

When the authentication code is successfully decrypted, the mutual authentication unit 210 authenticates the device information server 300.

Likewise, the mutual authentication unit 310 of the device information server 300 transmits the server certificate to the security GW 200 and receives the GW certificate from the security GW 200.

The mutual authentication unit 310 confirms that the communication partner is the security GW 200 based on the GW information (information concerning the security GW 200) contained in the received GW certificate.

The mutual authentication unit 310 encrypts the authentication code by using the server secret key and transmits the encrypted authentication code to the security GW 200.

The mutual authentication unit 310 receives the encrypted authentication code from the security GW 200 by using the GW secret key and decrypts the received authentication code by using the GW public key contained in the GW certificate.

When the authentication code is successfully decrypted, the mutual authentication unit 310 authenticates the security GW 200.

After S111, the process proceeds to S112.

In S112, the user enters the user ID and the password to the security GW 200.

The device ID registration unit 230 of the security GW 200 acquires the entered user ID and password.

After S112, the process proceeds to S113.

In S113, the device ID registration unit 230 of the security GW 200 transmits an authentication request, being communication data including the user ID and password, to the device information server 300.

After S113, the process proceeds to S114.

In S114, the user authentication unit 330 of the device information server 300 receives the authentication request and checks whether or not the user information file 391 contains user data including the user ID contained in the authentication request and the password contained in the authentication request.

If the user information file 391 contains user data including the user ID contained in the authentication request and the password contained in the authentication request, then the user who uses the security GW 200 is an authorized user.

If the user who uses the security GW 200 is an authorized user (YES), the user authentication unit 330 transmits an authentication response being communication data indicating that the user is authenticated, to the security GW 200, and the device ID registration unit 230 of the security GW 200 receives the authentication response. Then, the process proceeds to S115.

If the user who uses the security GW 200 is not an authorized user (NO), the user authentication unit 330 transmits an authentication response being communication data indicating that the user is not authenticated, to the security GW 200.

The device ID registration unit 230 of the security GW 200 receives the authentication response and displays an error message indicating that the user is not authenticated.

With the security GW 200 being unable to acquire the device information 292, the device information acquisition process (S110) is ended. The device certificate installation process (see FIG. 7) is ended without installing the device certificate 494 in the communication device 400.

In S115, the device ID registration unit 230 of the security GW 200 displays an authentication message indicating that the user is authenticated.

The user enters the device ID 291 of the communication device 400 to which the device certificate 494 is to be installed, to the security GW 200.

The device ID registration unit 230 of the security GW 200 acquires the entered device ID 291 and stores the acquired device ID 291 to the security GW storage unit 290.

After S115, the process proceeds to S116.

In S116, the device ID registration unit 230 of the security GW 200 generates a device information request containing the device ID 291 and transmits the generated device information request to the device information server 300.

The device information request is communication data that requests the device information 292.

After S116, the process proceeds to S117.

In S117, the device information management unit 340 of the device information server 300 receives the device information request and selects device information data including a device ID that is the same as the device ID 291 contained in the received device information request, from the device information file 392.

The device information management unit 340 acquires the device information 292 from the selected device information data, generates a device information response being communication data including the acquired device information 292, and transmits the generated device information response to the security GW 200.

The device information management unit 340 may set information (for example, IP address) concerning the security GW 200 contained in the device information request, to the selected device information data.

The device ID registration unit 230 of the security GW 200 receives the device information response, acquires the device information 292 from the received device information response, and stores the acquired device information 292 to the security GW storage unit 290.

After S117, the device information acquisition process (S110) is ended.

The communication data communicated in S113 to S117 of FIG. 8 is encrypted in transmission and decrypted in reception by the cryptographic communication unit 220 of the security GW 200 and the cryptographic communication unit 320 of the device information server 300.

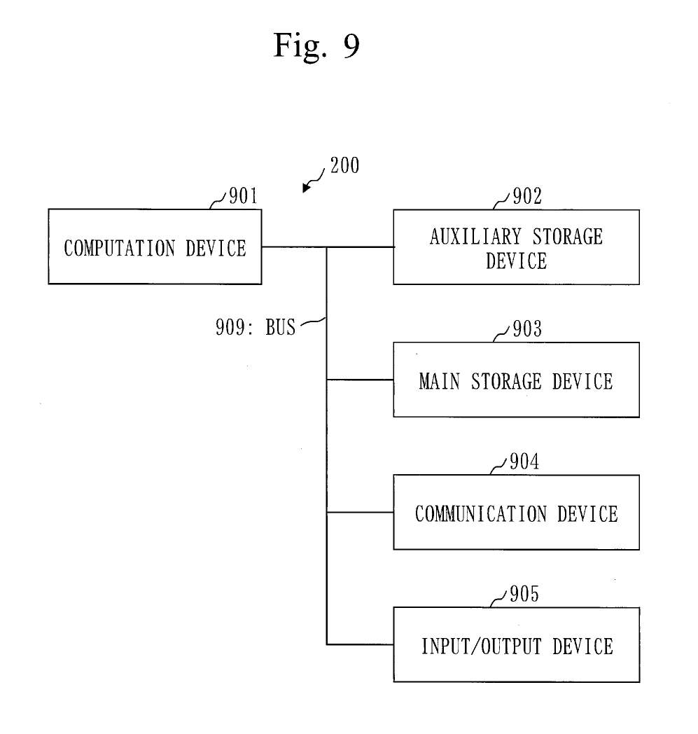

FIG. 9 is a diagram illustrating an example of a hardware configuration of the security GW 200 according to Embodiment 1.

An example of the hardware configuration of the security GW 200 according to Embodiment 1 will be described with reference to FIG. 9. The hardware configuration of the security GW 200 may be different from the configuration illustrated in FIG. 9.

The hardware configuration of each of the device information server 300, communication device 400, and certificate authority server 110 is the same as that of the security GW 200.

The security GW 200 is a computer including a computation device 901, an auxiliary storage device 902, a main storage device 903, a communication device 904, and an input/output device 905.

The computation device 901, auxiliary storage device 902, main storage device 903, communication device 904, and input/output device 905 are connected to a bus 909.

The computation device 901 is a CPU (Central Processing Unit) which executes a program.

The auxiliary memory device 902 is, for example, a ROM (Read Only Memory), a flash memory, or a hard disk device.

The main memory device 903 is, for example, a RAM (Random Access Memory).

The communication device 904 communicates in a wire-line or wireless manner via the Internet, a LAN (Local Area Network), a telephone network, or any other network.

The input/output device 905 is, for example, a mouse, a keyboard, or a display device.

The program is usually stored in the auxiliary memory device 902. The program is loaded to the main memory device 903, read by the computation device 901, and executed by the computation device 901.

For example, an operation system (OS) is stored in the auxiliary memory device 902. A program that implements the functions each explained as “unit” is stored in the auxiliary memory device 902. The OS and the program which implements the functions each explained as “unit” are loaded in the main memory device 903 and executed by the computation device 901. The “unit” can be replaced by “process” or “stage”.

Information, data, files, signal values, or variable values representing the results of processes such as “decide”, “determine”, “ extract”, “detect”, “set”, “register”, “select”, “generate”, “input”, and “output” are stored in the main memory device 903 or auxiliary memory device 902. Other data the security GW 200 uses are stored in the main memory device 903 or auxiliary memory device 902.

An embodiment of installing the device certificate 494 to the communication device 400 has been described in Embodiment 1.

For example, Embodiment 1 provides effects as follows.

The device certificate 494 can be installed in the communication device 400 securely and easily.

The device certificate 494 can be installed in the communication device 400 without using an external storage medium such as an IC card. Namely, the device certificate 494 can be installed in a communication device 400 that does not include a read/write device for using an external storage medium. This can prevent installation of the device certificate 494 into an unauthorized communication device which occurs when an IC card is stolen.

Installation of the device certificate 494 to an unauthorized communication device can be prevented, and communication with an unauthorized communication device in which the device certificate 494 is not installed can be prevented.

Embodiment 1 is an example of an embodiment of the device authentication system 100.

Namely, the device authentication system 100 does not necessarily include some of the constituent elements described in Embodiment 1. The device authentication system 100 may include a constituent element not described in Embodiment 1.

For example, the security GW 200 may include the function (certificate issuance unit 111) of the certificate authority server 110 and may generate a device certificate 494 without requesting the device certificate 494 from the certificate authority server 110. In this case, the device authentication system 100 need not include a certificate authority server 110.

The processing procedure described using flowcharts and the like in Embodiment 1 is an example of a processing procedure of a method and a program according to Embodiment 1. The method and program according to Embodiment 1 may be implemented by a processing procedure partly different from the processing procedure described in Embodiment 1.

### REFERENCE SIGNS LIST

100: device authentication system; 109: network; 110: certificate authority server; 111: certificate issuance unit; 200: security GW; 210: mutual authentication unit; 220: cryptographic communication unit; 230: device ID registration unit; 240: device certificate installation unit; 241: device ID inquiry unit; 242: device ID determination unit; 243: public key acquisition unit; 244: device certificate acquisition unit; 245: device certificate transmission unit; 290: security GW storage unit; 291: device ID; 292: device information; 293: IP address; 294: MAC address; 300: device information server; 310: mutual authentication unit; 320: cryptographic communication unit; 330: user authentication unit; 340: device information management unit; 390: server storage unit; 391: user information file; 392: device information file; 400: communication device; 410: mutual authentication unit; 420: cryptographic communication unit; 430: cipher key generation unit; 440: device certificate installation unit; 490: device storage unit; 491: device ID; 492: device public key; 493: device secret key; 494: device certificate; 901: computation device; 902: auxiliary storage device; 903: main storage device; 904: communication device; 905: input/output device; 909: bus

1. A device certificate providing apparatus comprising:
a processor to execute a device certificate providing program; and
a memory to store a first device identifier and a first communication address, and a device certificate providing program which, when executed by the processor, results in performance of steps comprising
transmitting a device identifier request containing, as a communication address of a destination, the first communication address stored, to a network connected to not less than one communication device, and receiving, from a first communication device out of the not less than one communication device, a communication device identifier that identifies the first communication device,
determining whether or not the communication device identifier received is the same device identifier as the first device identifier stored,
transmitting a device certificate being a digital certificate of the first communication device to the first communication device if it is determined that the communication device identifier is the same device identifier as the first device identifier,
acquiring the first device identifier, and
transmitting the first device identifier acquired, to a device information server which stores the first device identifier in correlation with the first communication address, and receiving the first communication address from the device information server,
wherein the memory stores the first device identifier acquired, and the first communication address acquired.

2. The device certificate providing apparatus according to claim 1, wherein the processor
acquires a public key from the first communication device if it is determined that the communication device identifier is the same device identifier as the first device identifier, and
acquires, as the device certificate, a digital certificate containing the public key acquired.

3. The device certificate providing apparatus according to claim 2, wherein the processor transmits the public key to a certificate authority server which generates a digital certificate; and receives the device certificate from the certificate authority server.

4. The device certificate providing apparatus according to claim 3,
wherein the memory stores first device information, and
wherein the processor transmits the public key and the first device information to the certificate authority server, and receives, from the certificate authority server, the device certificate being a digital certificate containing the public key and the first device information.

5. The device certificate providing apparatus according to claim 4,
wherein the device information server stores the first device identifier in correlation with the first communication address and the first device information,
wherein the processor
transmits the first device identifier acquired, to the device information server, and receives the first communication address and the first device information from the device information server, and
wherein the memory stores the first device identifier acquired, and the first communication address and the first device information which are acquired.

6. (canceled)

7. A device certificate providing system comprising:
the device certificate providing apparatus according to claim 1; and
a device information server to store the first communication address in correlation with the first device identifier, receive the first device identifier from the device certificate providing apparatus, and transmit the first communication address to the device certificate providing apparatus.

8. A device certificate providing system comprising:
the device certificate providing apparatus according to claim 2; and
a certificate authority server to receive the public key from the device certificate providing apparatus, generate the device certificate containing the received public key, and transmit the generated device certificate to the device certificate providing apparatus.

9. A non-transitory computer readable recording medium which stores a device certificate providing program that causes a computer to execute
transmitting a device identifier request containing, as a communication address of a destination, a first communication address stored in correlation with the first device identifier, to a network connected to not less than one communication device, and receiving, from a first communication device out of the not less than one communication device, a communication device identifier that identifies the first communication device,
determining whether or not the communication device identifier received is the same device identifier as the first device identifier,
transmitting a device certificate being a digital certificate of the first communication device to the first communication device if it is determined that the communication device identifier is the same device identifier as the first device identifier,
acquiring the first device identifier, and
transmitting the first device identifier acquired, to a device information server which stores the first device identifier in correlation with the first communication address, and receiving the first communication address from the device information server.
